(19) United States
(12) Patent Application Publication
(10) Pub. No.: US 2025/0363736 A1
(43) Pub. Date: Nov. 27, 2025

(54) VIRTUAL SPACE GENERATING METHOD, AND INFORMATION PROCESSING DEVICE

(71) Applicant: Panasonic Holdings Corporation, Osaka (JP)

(72) Inventor: Mitsuhiro ISHIZUKA, Osaka (JP)

(73) Assignee: Panasonic Holdings Corporation, Osaka (JP)

(21) Appl. No.: 19/289,356

(22) Filed: Aug. 4, 2025

Related U.S. Application Data
(63) Continuation of application No. PCT/JP2024/001244, filed on Jan. 18, 2024.

(30) Foreign Application Priority Data
Feb. 6, 2023 (JP) 2023-015834

(51) Int. Cl. G06T 17/00; G06T 5/80

(52) U.S. Cl. CPC G06T 17/00; G06T 5/80

(57) ABSTRACT

A virtual space generating method comprises receiving an input of distance information indicating distances among at least three or more feature points measured in a real space in which the at least three or more feature points are provided; receiving an input of 3D scan information obtained by scanning the real space and a real space object provided in the real space with a 3D scanner; and generating a virtual space on the computer on a basis of the distance information inputted and the 3D scan information inputted, the virtual space including a virtual space object corresponding to the real space object.

### CROSS REFERENCE TO RELATED APPLICATIONS

This is a continuation application of International Application No. PCT/JP2024/001244, with an international filing date of Jan. 18, 2024, which claims priority of Japanese Patent Application No. 2023-015834, filed on Feb. 6, 2023, each of the content of which is incorporated herein by reference in its entirety.

### TECHNICAL FIELD

The present disclosure relates to a generation method of a virtual space corresponding to a real space in which an object such as a projector is provided.

### BACKGROUND ART

JP 2018-207373 A discloses a technology for detecting and recalibrating a deviation in a relative position between a projection plane and a projection-type display device.

### SUMMARY

The present disclosure provides a virtual space generating method capable of generating a virtual space close to an actual space (Hereinafter, it is also described as a real space.).

A virtual space generating method according to one aspect of the present disclosure is a virtual space generating method executed by a computer, the virtual space generating method including: receiving an input of distance information indicating distances among at least three or more feature points measured in a real space in which the at least three or more feature points are provided; receiving an input of 3D scan information obtained by scanning the real space and a real space object provided in the real space with a 3D scanner; and generating a virtual space on the computer on the basis of the distance information inputted and the 3D scan information inputted, the virtual space including a virtual space object corresponding to the real space object.

A virtual space generating method according to one aspect of the present disclosure can generate a virtual space close to a real space.

### BRIEF DESCRIPTION OF DRAWINGS

FIG. 1 is a diagram illustrating a configuration of a projection system according to an embodiment;

FIG. 2 is a diagram illustrating a real space in which a video is projected by a projector;

FIG. 3 is a flowchart of Example 1 of a generation method of a virtual space;

FIG. 4 is a flowchart of Example 2 of a generation method of a virtual space;

FIG. 5 is a flowchart of Example 3 of a generation method of a virtual space; and

FIG. 6 is a flowchart of a calibration method of a projection range of a video in a real space.

### DETAILED DESCRIPTION

Hereinafter, embodiments will be described with reference to the drawings. Note that the embodiments described below illustrate comprehensive or specific examples. Numerical values, shapes, materials, components, arrangement positions and connection modes of the components, steps, order of the steps, and the like shown in the following embodiments are merely examples, and are not intended to limit the present disclosure. Furthermore, among the constituent elements in the following embodiments, constituent elements not recited in the independent claims are described as arbitrary constituent elements.

Note that, each drawing is a schematic diagram, and is not necessarily strictly illustrated. Furthermore, in the drawings, substantially the same components are denoted by the same reference numerals, and redundant description may be omitted or simplified.

### Embodiment

### [Configuration]

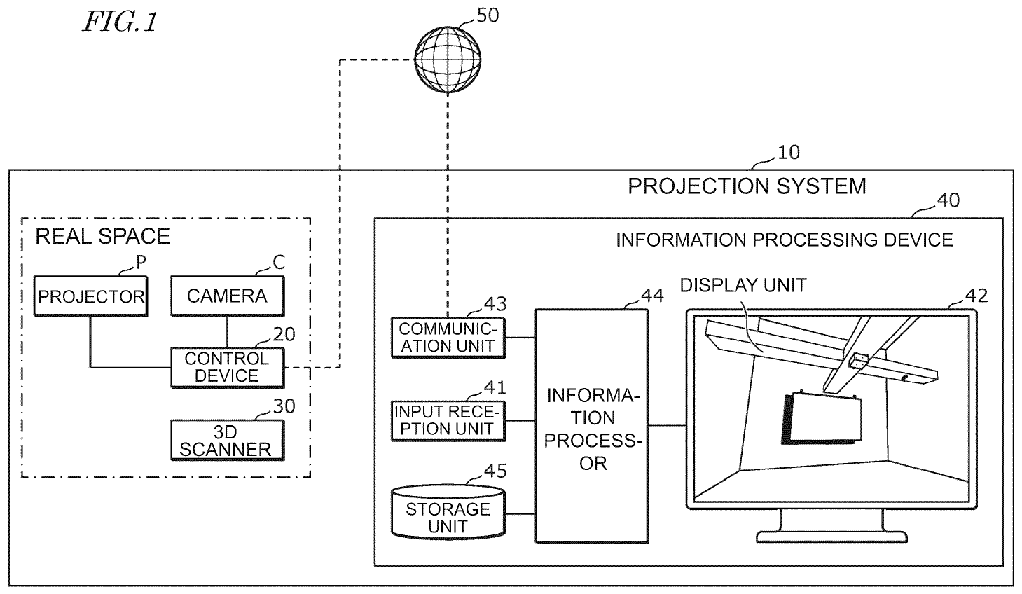

First, a configuration of a projection system according to an embodiment will be described. FIG. 1 is a diagram illustrating a configuration of a projection system according to an embodiment.

A projection system 10 is a system that can display a virtual space simulating an actual space (Hereinafter, it is also described as a real space.) in which projection of a video by the projector P (such as projection mapping) is performed on the information processing device 40 and simulate projection of a video in the real space using the virtual space. The projection system 10 includes a projector P, a camera C, a control device 20, a 3D scanner 30, and an information processing device 40. The projector P, the camera C, and the 3D scanner 30 are provided in the real space, and the control device 20 is provided in the real space or around the real space. The information processing device 40 is provided, for example, at a place farther from the real space than the control device 20.

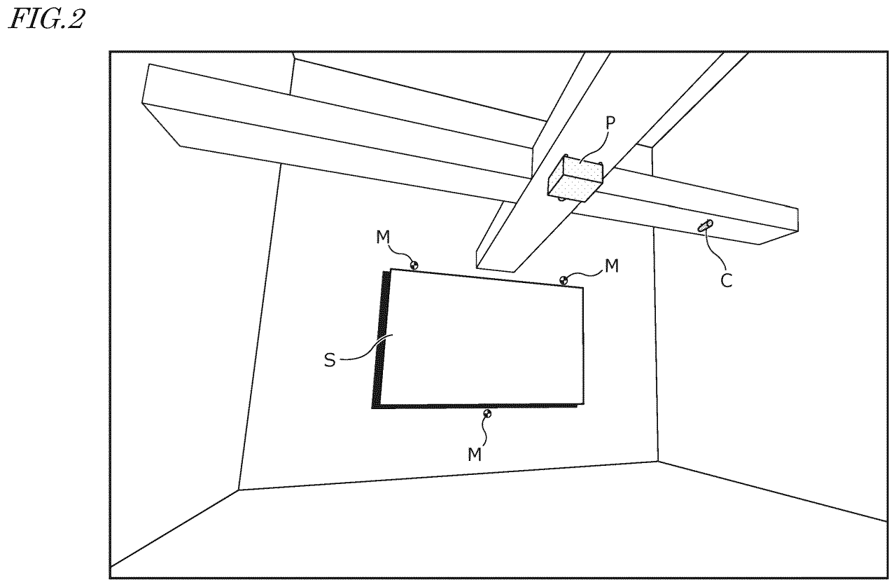

First, a real space and members and devices provided in the real space will be described. FIG. 2 is a diagram illustrating a real space in which a video is projected by the projector P. As illustrated in FIG. 2, a projection surface S, a plurality of markers M, a projector P, and a camera C are provided (fixed) in the real space. Each of the projection surface S, the plurality of markers M, the projector P, and the camera C is an example of a real space object.

The projection surface S is a screen on which a video (moving image or still image) is projected by the projector P. In the example of FIG. 2, the projection surface S is positioned so as to protrude toward the indoor side from the wall surface of the real space. The shape of the projection surface S is, for example, a rectangle.

The marker M is a member provided in the real space for alignment between the real space and the virtual space. The marker M functions as a feature point. The markers M are provided at least at three points in the real space, and the at least three markers M are arranged so as not to be aligned on a straight line. The markers M are provided around the projection surface S, for example. In order for the marker M to function as a feature point, it is necessary that the marker M is shown in an image captured by the camera C and is recognized by the 3D scanner 30. For example, if the marker M is formed of a retroreflective material, the above requirement is satisfied.

Note that the marker M may be a self-luminous marker realized by a light emitting diode (LED) or the like, and it is not essential that the marker M is formed of a retroreflective material. In the following embodiment, as an example, it is assumed that three markers M are disposed.

The projector P projects a video for projection mapping on the projection surface S under the control of the control device 20. The projector P is fixed to a ceiling, a wall, a beam, or the like in a real space. The projector P is realized by, for example, an optical system such as a laser light source, a phosphor wheel, an image display element, and a projection lens. Specifically, the image display element is a digital micromirror device (DMD), a liquid crystal on silicon (LCOS), or the like.

The camera C captures an image (still image) showing the entire projection surface S and the plurality of markers M under the control of the control device 20. The camera C is fixed to a ceiling, a wall, a beam, or the like in the real space. The camera C is realized by an image sensor, a lens, and the like.

The control device 20 controls projection of a video by the projector P and capturing of an image by the camera C. Specifically, the control device 20 performs control processing related to projection mapping. Such control processing includes calibration processing using an image captured by the camera C for projecting a video in accordance with the projection surface S. The control device 20 is, for example, a general-purpose device such as a personal computer in which an application program for executing the control process is installed, but may be a dedicated device of the projection system 10.

The 3D scanner 30 is a device that scans a structure to generate point cloud data (hereinafter also referred to as 3D scan information) indicating unevenness of the structure. The 3D scanner may be a phase difference type 3D scanner or a time of flight (ToF) type 3D scanner. The 3D scanner may be a stationary type or a handy type. Furthermore, as the 3D scanner, a portable terminal such as a smartphone or a tablet terminal having a light detection and ranging (LiDAR) function may be used.

The information processing device 40 generates a virtual space and displays the virtual space on a display unit 42. The information processing device 40 is a general-purpose device such as a personal computer, but may be a dedicated device of the projection system 10. Furthermore, the information processing device 40 may be a server device. Specifically, the information processing device 40 includes an input reception unit 41, the display unit 42, a communication unit 43, an information processor 44, and a storage unit 45.

The input reception unit 41 is an input receiving device that receives a user's input (operation). The input reception unit 41 is, for example, a keyboard and a mouse, but may be a touch panel or the like.

The display unit 42 is a monitor that displays an image. The display unit 42 is realized by, for example, a display panel such as a liquid crystal panel or an organic electro luminescence (EL) panel. Note that the display unit 42 may be a device separate from the information processing device 40.

The communication unit 43 is a communication circuit for the information processing device 40 to communicate with the control device 20 via a wide area communication network 50. The communication performed by the communication unit 43 is, for example, wired communication, but may be wireless communication. The communication standard used for communication is also not particularly limited.

Note that, in a case where the information processing device 40 is positioned at a place relatively close to the real space, the information processing device 40 may include a communication unit that communicates with the control device 20 via a local communication network, and may communicate with the control device 20 using the communication unit.

The information processor 44 generates a virtual space and displays the generated virtual space on the display unit 42. Furthermore, the information processor 44 simulates the projection range of the video in the real space using the generated virtual space. Specifically, the information processor 44 is realized by a processor or a microcomputer. The function of the information processor 44 is implemented by a processor or a microcomputer constituting the information processor 44 executing a computer program stored in the storage unit 45.

The storage unit 45 is a storage device that stores information necessary for information processing related to generation of the virtual space or the like, such as a computer program executed by the information processor 44. Specifically, the storage unit 45 is realized by a semiconductor memory, a hard disk drive (HDD), or the like.

The computer program stored in the storage unit 45 includes a program for generating a virtual space (3D model) from 3D scan information as described later, and a simulation program for simulating a real space using the generated virtual space. According to the simulation program, the user can grasp at which position in the virtual space a video is projected when the video is projected from the virtual projector, and what kind of image can be obtained when an image is captured by the virtual camera.

### Example 1 of Generation Method of Virtual Space

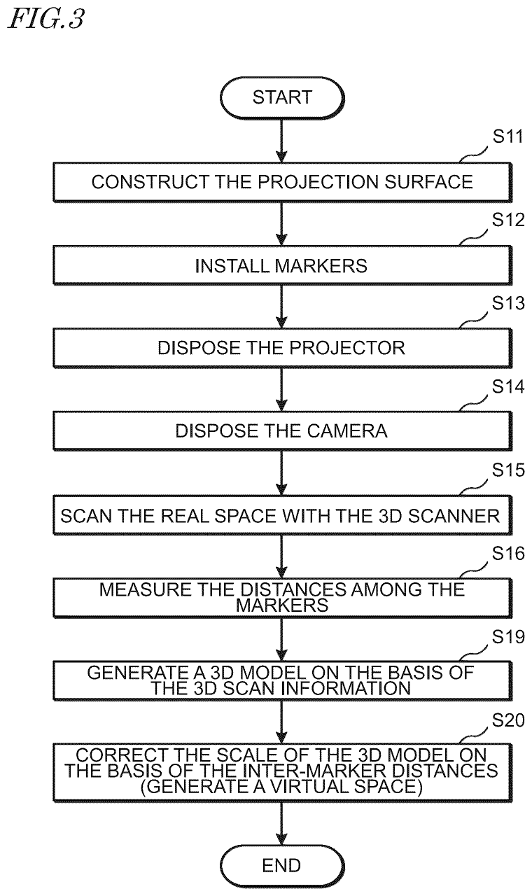

Next, Example 1 of a generation method of a virtual space will be described. FIG. 3 is a flowchart of Example 1 of the generation method of a virtual space.

First, a worker (person) constructs the projection surface S on the wall of the real space (S11), and installs three markers M on the wall around the projection surface S (S12). Furthermore, the worker disposes the projector P in the real space (S13). The projector P is disposed such that an image is projected on the projection surface S. The worker disposes the camera C in the real space (S14). The camera C is disposed such that the projection surface S and the three markers M are within an image capturing range of the camera C.

Next, the worker scans the real space with the 3D scanner 30 to generate 3D scan information (S15). In other words, the 3D scanner 30 generates the 3D scan information on the basis of the operation of the worker. The generated 3D scan information is stored in a storage unit included in the 3D scanner 30. The scan of the real space is performed on each member and device of the projection surface S, the three marker M, the projector P, and the camera C, and the periphery (real space itself) of each member and device.

Next, the worker measures (actually measures) the distances among the three markers M in the real space (S16). The distances among the markers M is measured using a measuring instrument different from the 3D scanner 30. As the measuring instrument, equipment capable of measuring the distances among the markers M with higher accuracy than the 3D scanner 30 is used. The worker measures the distances among the three markers M using, for example, a tape measure or a ruler. In a case where the number of markers M is three, three distances among the markers M are measured. Hereinafter, the distances among the plurality of markers M measured in step S16 is simply referred to as an inter-marker distance.

Thereafter, the information processor 44 of the information processing device 40 generates a 3D model of the real space on the basis of the 3D scan information stored in the 3D scanner 30 (S19). The information processor 44 generates a 3D model of the real space using, for example, an existing algorithm (computer program) capable of generating a 3D model from 3D scan information (point cloud data).

Note that, in step S19, the user of the information processing device 40 receives the 3D scan information stored in the 3D scanner 30 from the worker, and inputs the 3D scan information to the information processing device 40. For example, the 3D scan information is stored in a recording medium such as a USB memory or an SD card, and the 3D scan information is input from the recording medium to the information processing device 40. The control device 20 may acquire the 3D scan information from the 3D scanner 30, and the 3D scan information may be transmitted from the control device 20 to the information processing device 40, whereby the 3D scan information may be input to the information processing device 40. A method of inputting the 3D scan information to the information processing device 40 is not particularly limited. The input of the 3D scan information is received by the information processor 44.

Next, the information processor 44 generates a virtual space by correcting (determining) the scale of the 3D model generated in step S19 on the basis of the inter-marker distances measured in step S16 (S20). The information processor 44 corrects the scale of the generated 3D model such that the inter-marker distances in the virtual space substantially matches (becomes closest to) the inter-marker distances measured in step S16. Therefore, a virtual space (3D model with a corrected scale) with a small error from the real space is generated. Note that generating the virtual space means that information for three-dimensionally displaying the virtual space (3D model) is stored in the storage unit 45. Therefore, the information processor 44 reads the information and three-dimensionally displays the virtual space on the display unit 42, and the user can access the virtual space.

When the 3D scan information is generated in step S15, the scan in the real space is performed on the real space object such as the projection surface S, the three marker M, the projector P, and the camera C. Therefore, in the virtual space, the virtual projection surface, the three-point virtual marker, the virtual projector, and the virtual camera are disposed as the virtual space object.

Note that, in step S20, the user of the information processing device 40 receives the measurement result of the inter-marker distances in step S16 from the worker, and manually inputs the inter-marker distance (numerical value) to the input reception unit 41. The input reception unit 41 and the information processor 44 receive an input of inter-marker distances.

As described above, in Example 1 of the generation method of a virtual space, the information processor 44 included in the information processing device 40 receives the input of the distance information indicating the distances among the three or more feature points measured in the real space in which at least the three or more markers M (feature points) are provided, and receives the input of the 3D scan information obtained by scanning the real space and the real space object provided in the real space with the 3D scanner. The information processor 44 generates a virtual space on the information processing device 40 (on the computer) on the basis of the distance information inputted and the 3D scan information inputted, the virtual space including a virtual space object corresponding to the real space object.

In Example 1 of the generation method of a virtual space, since the virtual space is generated by correcting the scale of the 3D model on the basis of the inter-marker distances, the consistency between the real space and the virtual space can be improved. That is, in Example 1 of the generation method of a virtual space, the virtual space close to the real space can be generated.

### Example 2 of Generation Method of Virtual Space

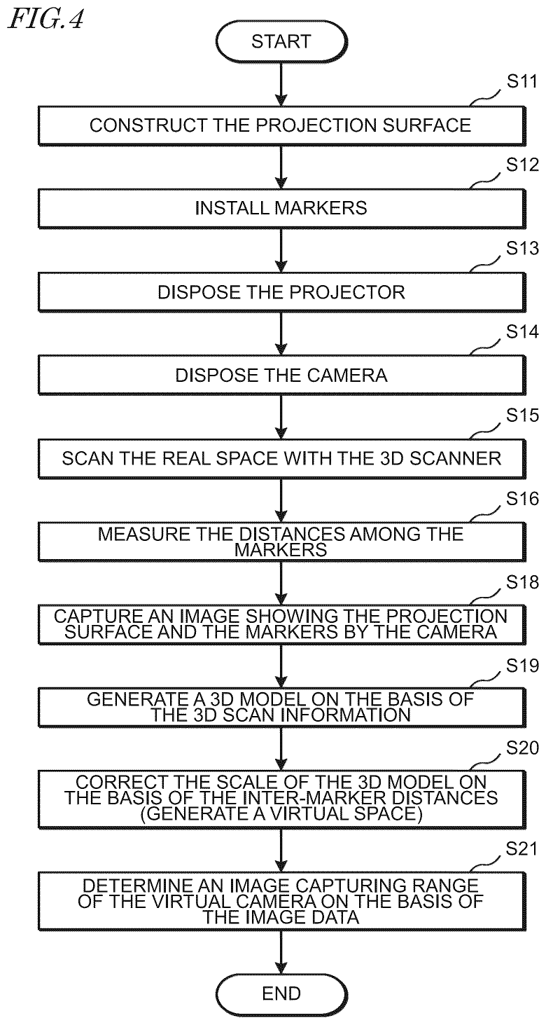

Next, Example 2 of the generation method of a virtual space will be described. FIG. 4 is a flowchart of Example 2 of the generation method of a virtual space.

Since the processing in steps S11 to S16 is similar to that in Example 1 of the generation method of a virtual space, detailed description thereof will be omitted. After step S16, the worker performs a predetermined operation on the control device 20 to cause the camera C provided in the real space to capture an image. The camera C captures an image showing the projection surface S and the three markers M in the real space (S18). The image data of the captured image is stored in a storage unit of the control device 20. Note that at least two of the three markers M may be shown in the image.

Thereafter, the information processor 44 of the information processing device 40 generates a 3D model of the real space on the basis of the 3D scan information stored in the 3D scanner 30 (S19). Furthermore, the information processor 44 generates a virtual space by correcting (determining) the scale of the 3D model generated in step S19 on the basis of the inter-marker distances measured in step S16 (S20). Since the processing in steps S19 to S20 is similar to that in Example 1 of the generation method of a virtual space, detailed description thereof will be omitted.

Next, the information processor 44 determines an image capturing range of the virtual camera in the virtual space on the basis of the image data of the image captured in step S18 (S21). The image capturing range means a rectangular range shown in an image captured by the virtual camera in the virtual space.

Specifically, the information processor 44 determines the image capturing range of the virtual camera such that the positions of at least two markers M shown in the image (image captured by the camera C) indicated by the image data and the inter-marker distances substantially match with (become closest to) the positions of at least two virtual markers and the inter-marker distances in the image captured by the virtual camera.

To supplement the input method of the image data, in step S21, the communication unit 43 of the information processing device 40 receives the image data stored in the storage unit included in the control device 20 from the control device 20 in step S18, and the information processor 44 receives an input of the received image data. Note that the user of the information processing device 40 may receive the image data from the worker and input the image data to the information processing device 40. In this case, the image data is stored in a recording medium such as a USB memory or an SD card, and is input from the recording medium to the information processing device 40. The method of inputting the image data is not particularly limited.

As described above, in Example 2 of the generation method of a virtual space, the information processor 44 included in the information processing device 40 receives an input of the image data of an image captured by the camera C in the real space, and determines the image capturing range of the virtual camera (camera included in the virtual space object) on the basis of the positions of the plurality of markers M in the image indicated by the input image data.

In Example 2 of the generation method of a virtual space, the image capturing range of the virtual camera in the virtual space is determined such that the positions of the markers M in the image captured by the camera C match the positions of the virtual markers in the image captured by the virtual camera. Therefore, it is possible to improve the consistency between the image capturing range of the camera C in the real space and the image capturing range of the virtual camera in the virtual space. That is, in Example 2 of the generation method of a virtual space, the virtual space close to the real space can be generated.

### Example 3 of Generation Method of Virtual Space

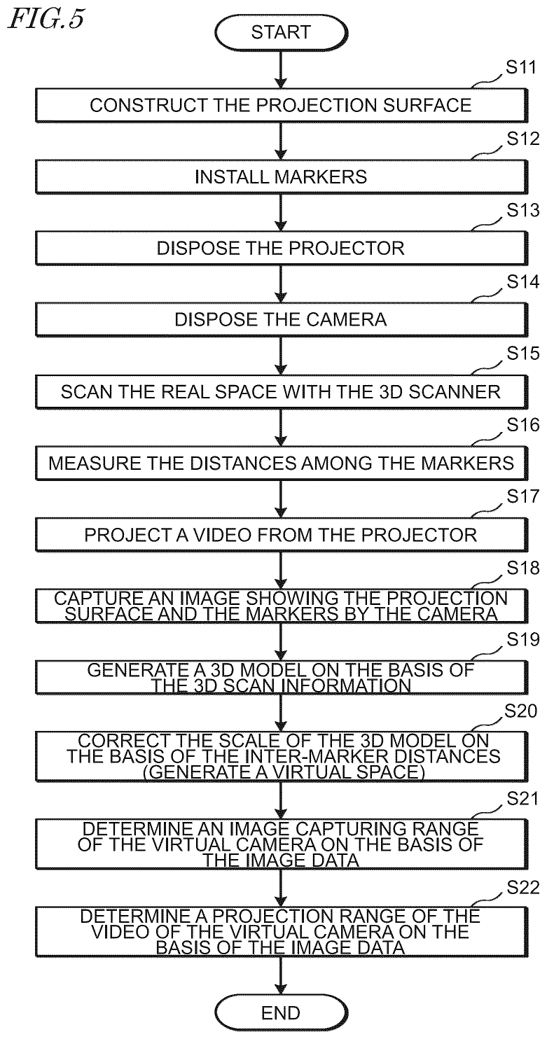

Next, Example 3 of the generation method of a virtual space will be described. FIG. 5 is a flowchart of Example 3 of the generation method of a virtual space.

Since the processing in steps S11 to S16 is similar to that in Example 1 of the generation method of a virtual space, detailed description thereof will be omitted. After step S16, the worker performs a predetermined operation on the control device 20 to cause the projector P provided in the real space to project a predetermined video. The projector P projects the predetermined video toward the projection surface S in the real space (S17).

Next, the worker performs a predetermined operation on the control device 20 to cause the camera C provided in the real space to capture an image. The camera C captures an image showing the projection surface S and the three markers M in the real space (S18). In Example 3 of the generation method of a virtual space, since the predetermined video is projected in step S17, the predetermined video is also shown in the image captured in step S18. The image data of the captured image is stored in the storage unit of the control device 20.

Thereafter, the information processor 44 of the information processing device 40 generates a 3D model of the real space on the basis of the 3D scan information stored in the 3D scanner 30 (S19). Furthermore, the information processor 44 generates a virtual space by correcting (determining) the scale of the 3D model generated in step S19 on the basis of the inter-marker distances measured in step S16 (S20). Since the processing in steps S19 to S20 is similar to that in Example 1 of the generation method of a virtual space, detailed description thereof will be omitted.

Next, the information processor 44 determines an image capturing range of the virtual camera in the virtual space on the basis of the image data of the image captured in step S18 (S21). Since the processing in step S21 is similar to that in Example 2 of the generation method of a virtual space, detailed description thereof will be omitted.

Next, the information processor 44 determines a projection range of the video of the virtual projector in the virtual space on the basis of the image data of the image captured in step S18 (S22). The projection range means a rectangular range in which the virtual projector projects a video in the virtual space (a range irradiated with light emitted from the virtual projector). The projection range is paraphrased as a projection position of the video.

Specifically, the information processor 44 determines the projection range of the video of the virtual projector such that the projection range of the video projected by the virtual projector in the image captured by the virtual camera substantially matches with (becomes closest to) the projection range of the video projected by the projector P in the image captured by the camera C.

As described above, in Example 3 of the generation method of a virtual space, the information processor 44 included in the information processing device 40 receives input of image data of an image captured by the camera C in the real space, and determines the projection range of the video of the virtual projector on the basis of the projection range of the video in the image indicated by the input image data.

In Example 3 of the generation method of a virtual space, the projection range of the video of the virtual projector in the virtual space is determined such that the projection range of the video in the image captured by the camera C matches the projection range of the video in the image captured by the virtual camera. As described in Example 2 of the generation method of a virtual space, the image capturing range of the virtual camera in the virtual space substantially matches with the image capturing range of the camera C in the real space. Consequently, according to Example 3 of the generation method of a virtual space, it is possible to improve consistency between the projection range of the video of the projector P in the real space and the projection range of the video of the virtual projector in the virtual space. That is, in Example 3 of the generation method of a virtual space, the virtual space close to the real space can be generated.

### [Calibration Method of Projection Range of Video in Real Space]

Meanwhile, in a case where a deviation occurs in the projection range of the video of the projector P in the real space, it is common that a worker performs work in the real space to perform geometric distortion correction (Hereinafter, it is simply described as geometric correction.) of the video.

On the other hand, in the projection system 10, it is possible to generate geometric correction data for geometrically correcting the video of the real space by simulation in the virtual space and transmit the geometric correction data to the control device 20.

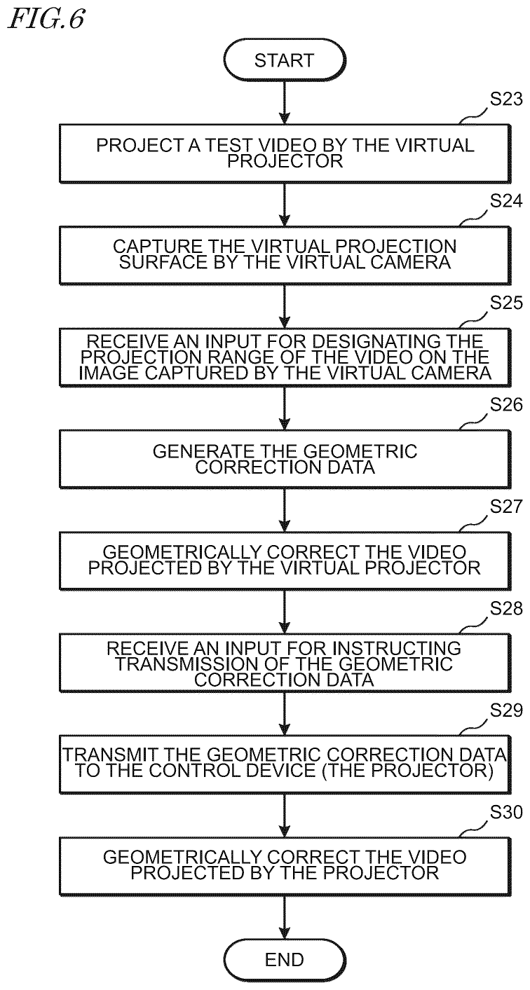

Hereinafter, a calibration method of the projection range of the video in such a real space will be described. FIG. 6 is a flowchart of a calibration method of the projection range of the video in the real space. Note that the following calibration method is performed after the virtual space reflecting the image capturing range of the camera C and the projection range of the video of the projector P when there is a deviation in the projection range of the video of the projector P in the real space is generated according to Example 3 of the generation method of a virtual space described above.

The user makes a predetermined input to the input reception unit 41 of the information processing device 40 to cause a virtual projector provided in the virtual space to project a test video including a pattern for coordinate detection. The virtual projector projects a test video toward the projection surface S in the virtual space (S23).

Next, the user makes a predetermined input to the input reception unit 41 of the information processing device 40 to cause the virtual camera provided in the virtual space to capture an image. The virtual camera captures an image showing the virtual projection surface on which the test video is projected in the virtual space (S24). The image data of the captured image is stored in the storage unit 45 of the information processing device 40.

Next, the user performs an input for designating the projection range of the video on the image captured in step S24, and the input reception unit 41 receives such an input (S25). Specifically, the input for designating the projection range of the video is an input for designating positions of four corners of the video to be projected on the image captured by the virtual camera.

On the basis of the received input, the information processor 44 generates geometric correction data for correcting the projection range of the current video to the designated projection range (S26). Specifically, the information processor 44 can generate the geometric correction data by detecting the coordinates of each of the designated four corner positions (four point positions) using the coordinate detection pattern shown in the image.

Next, the information processor 44 geometrically corrects the video projected by the virtual projector on the basis of the geometric correction data generated (S27). As a result, the projection range of the video projected from the virtual projector in the virtual space is changed to the projection range designated in step S25.

After confirming that the projection range of the video has been geometrically corrected as intended in the virtual space, the user performs an input for instructing transmission of the geometric correction data, and the input reception unit 41 receives such an input (S28). The information processor 44 transmits the geometric correction data generated in step S26 to the control device 20 using the communication unit 43 on the basis of the received input (S29).

When receiving the geometric correction data, the control device 20 transmits the received geometric correction data to the projector P. That is, in step S29, it can be said that the information processing device 40 (information processor 44) transmits the geometric correction data to the projector P via the control device 20. The projector P geometrically corrects the video projected by the projector P on the basis of the received geometric correction data (S30). As a result, the projection range of the video projected from the projector Pin the real space is changed. That is, the calibration of the projection range of the video in the real space is completed.

As described above, the calibration method generates geometric correction data for geometrically correcting the projection range of the video of the projector P in the real space by simulating the projection range of the video by the virtual projector in the virtual space, and transmits the geometric correction data generated, to the projector P provided in the real space.

According to such a calibration method, work (processing corresponding to steps S23 to S27) for generating geometric correction data, which is generally performed in the real space, can be performed on the virtual space (information processing device 40), and the work in the real space can be reduced. In the calibration method, for example, when the projection mapping is demonstrated in the real space, it is possible to geometrically correct the projection range of the video of the projector P while minimizing the interruption of the demonstration.

### [Effects and the Like]

Hereinafter, a technology obtained from the disclosure contents of the present specification will be exemplified, and effects and the like obtained by the exemplified technology will be described.

Technology 1 is a virtual space generating method executed by a computer such as a projection system 10 (information processing device 40), the virtual space generating method including: receiving an input of distance information indicating distances among at least three or more feature points measured in a real space in which the at least three or more feature points are provided; receiving an input of 3D scan information obtained by scanning the real space and a real space object provided in the real space with a 3D scanner 30; and generating a virtual space on the computer on the basis of the distance information inputted and the 3D scan information inputted, the virtual space including a virtual space object corresponding to the real space object. The feature point is the marker M in the above embodiment.

In such a virtual space generating method, since the virtual space is generated on the basis of not only the 3D scan information but also the distance information indicating the distances among the feature points, the consistency between the real space and the virtual space can be improved. That is, the virtual space generating method can generate a virtual space close to the real space.

Technology 2 is the virtual space generating method of technology 1 in which a position of the virtual space object in the virtual space is determined on the basis of the distance information.

Such a virtual space generating method can improve the consistency between the position of the real space object and the position of the virtual space object.

Technology 3 is the virtual space generating method of technology 1 or 2, in which the real space object includes a camera C, in the real space, the camera C captures an image showing a plurality of the feature points, and the virtual space generating method further including: receiving an input of image data of the image captured; and determining an image capturing range of a virtual camera included in the virtual space object on the basis of positions of the plurality of feature points in the image indicated by the image data inputted.

Such a virtual space generating method can improve consistency between an image capturing range of the camera C in the real space and the image capturing range of the virtual camera in the virtual space.

Technology 4 is the virtual space generating method of any one of technologies 1 to 3, in which the real space object includes a camera C, a projector P, and a projection surface S on which the projector P projects a video, in the real space, the camera C captures an image in which the projection surface S when the projector P is projecting a video is shown, and the virtual space generating method further including: receiving an input of image data of the image captured; and determining, on a basis of a projection range of the video in the image indicated by the image data inputted, a projection range of a video of a virtual projector included in the virtual space object.

Such a virtual space generating method can improve consistency between the projection range of the video of the projector P in the real space and the projection range of the video of the virtual projector in the virtual space.

Technology 5 is the virtual space generating method according to technology 4, further including: generating geometric correction data for geometrically correcting a projection range of the video of the projector P in the real space by performing a simulation of the projection range of the video by the virtual projector in the virtual space; and transmitting the geometric correction data generated, to the projector P provided in the real space.

In such a virtual space generating method, work for generating geometric correction data generally performed in the real space can be performed in the virtual space, and the work in the real space can be reduced.

Technology 6 is the virtual space generating method of any of technologies 1 to 5, in which the distances among the three or more feature points are measured using a measuring instrument different from the 3D scanner 30.

In such a virtual space generating method, the distances among the three or more feature points are measured by the measuring instrument having higher measurement accuracy than the 3D scanner 30, so that the consistency between the real space and the virtual space can be improved.

Technology 7 is a non-transitory computer-readable storage medium storing a program for causing a computer to execute the virtual space generating method of any one of technologies 1 to 6.

Such a program can improve consistency between the real space and the virtual space.

Technology 8 is an information processing device 40 including an information processor configured to:
receive an input of distance information indicating distances among three or more feature points measured in a real space in which at least the three or more feature points are provided;
receive an input of 3D scan information obtained by scanning the real space and a real space object provided in the real space with a 3D scanner 30; and
generate a virtual space on the computer on a basis of the distance information inputted and the 3D scan information inputted, the virtual space including a virtual space object corresponding to the real space object.

Such an information processing device 40 can improve consistency between the real space and the virtual space.

### Other Embodiments

Although the virtual space generating method and the projection system according to the embodiment have been described above, the present disclosure is not limited to the above embodiment.

For example, in the embodiment described above, the projection system is implemented by a plurality of devices. In this case, each component included in the projection system may be distributed to a plurality of devices in any manner. Furthermore, the projection system may include a device not described in the above embodiment. For example, the projection system may include a cloud server.

In this case, some or all of the functional components described as being included in the information processing device in the above embodiment may be included in the cloud server. In other words, a part or all of the processing described to be executed by the information processing device 40 may be executed by the cloud server. For example, if information for three-dimensionally displaying the virtual space (3D model) is stored in the cloud server, each of the plurality of information processing devices can access the virtual space.

Furthermore, the projection system may be realized as a single device. For example, the projection system may be realized as a single device corresponding to an information processing device.

Furthermore, in the above embodiment, processing executed by a specific processing unit may be executed by another processing unit. Furthermore, the order of a plurality of processing may be changed, or the plurality of processing may be executed in parallel.

Furthermore, in the above embodiment, each component may be implemented by executing a software program suitable for each component. Each component may be implemented by a program execution unit such as a CPU or a processor reading and executing a software program recorded in a recording medium such as a hard disk or a semiconductor memory.

Furthermore, each component may be realized by hardware. For example, each component may be a circuit (or an integrated circuit). These circuits may constitute one circuit as a whole or may be separate circuits. Furthermore, each of these circuits may be a general-purpose circuit or a dedicated circuit.

Furthermore, general or specific aspects of the present disclosure may be implemented by a system, a device, a method, an integrated circuit, a computer program, or a computer-readable recording medium such as a CD-ROM. Furthermore, the present disclosure may be realized by an arbitrary combination of a system, a device, a method, an integrated circuit, a computer program, and a recording medium. For example, the present disclosure may be realized as the projection system or the information processing device of the above embodiment. The present disclosure may be realized as a program (computer program product) for causing a computer to execute the virtual space generating method of the above embodiment, or may be realized as a computer-readable non-transitory recording medium storing such a program.

In addition, the present disclosure also includes a mode obtained by applying various modifications conceived by those skilled in the art to each embodiment, or a mode realized by arbitrarily combining components and functions in each embodiment without departing from the spirit of the present disclosure.

The virtual space generating method of the present disclosure can generate a virtual space close to a real space.

What is claimed is:

1. A virtual space generating method executed by a computer, the virtual space generating method comprising:
receiving an input of distance information indicating distances among at least three or more feature points measured in a real space in which the at least three or more feature points are provided;
receiving an input of 3D scan information obtained by scanning the real space and a real space object provided in the real space with a 3D scanner; and
generating a virtual space on the computer on a basis of the distance information inputted and the 3D scan information inputted, the virtual space including a virtual space object corresponding to the real space object.

2. The virtual space generating method according to claim 1, wherein
a position of the virtual space object in the virtual space is determined on a basis of the distance information.

3. The virtual space generating method according to claim 1, wherein
the real space object includes a camera,
in the real space, the camera captures an image showing a plurality of the feature points, and
the virtual space generating method further comprising: receiving an input of image data of the image captured; and
determining an image capturing range of a virtual camera included in the virtual space object on a basis of positions of the plurality of feature points in the image indicated by the image data inputted.

4. The virtual space generating method according to claim 1, wherein
the real space object includes a camera, a projector, and a projection surface on which the projector projects a video,
in the real space, the camera captures an image in which the projection surface when the projector is projecting a video is shown, and
the virtual space generating method further comprising:
receiving an input of image data of the image captured; and
determining, on a basis of a projection range of the video in the image indicated by the image data inputted, a projection range of a video of a virtual projector included in the virtual space object.

5. The virtual space generating method according to claim 4, further comprising:
generating geometric correction data for geometrically correcting a projection range of the video of the projector in the real space by performing a simulation of the projection range of the video by the virtual projector in the virtual space; and
transmitting the geometric correction data generated, to the projector provided in the real space.

6. The virtual space generating method according to claim 1, wherein
the distances among the three or more feature points are measured using a measuring instrument different from the 3D scanner.

7. A non-transitory computer-readable storage medium storing a program for causing a computer to execute the virtual space generating method according to claim 1.

8. An information processing device comprising
an information processor configured to:
receive an input of distance information indicating distances among three or more feature points measured in a real space in which at least the three or more feature points are provided;
receive an input of 3D scan information obtained by scanning the real space and a real space object provided in the real space with a 3D scanner; and
generate a virtual space on the computer on a basis of the distance information inputted and the 3D scan information inputted, the virtual space including a virtual space object corresponding to the real space object.
